(19) United States
(12) Patent Application Publication
(10) Pub. No.: US 2026/0281832 A1
(43) Pub. Date: Sep. 17, 2026

(54) METHOD, USER EQUIPMENT, AND BASE STATION FOR PERFORMING EARLY UPLINK SYNCHRONIZATION FOR L1/L2 TRIGGERED MOBILITY

(71) Applicant: SHARP KABUSHIKI KAISHA, Sakai City, Osaka (JP)

(72) Inventors: CHIA-HUNG LIN, Taipei (TW); MEI-JU SHIH, Taipei (TW); CHIA-HSIN LAI, Taipei (TW); YEN-HUA LI, Taipei (TW)

(21) Appl. No.: 19/471,071

(22) PCT Filed: Mar. 29, 2024
(86) PCT No.: PCT/CN2024/084687

§ 371 Date: Sep. 30, 2025

Related U.S. Application Data
(60) Provisional application No. 63/456,443, filed on Mar. 31, 2023.

(51) Int. Cl. H04W 36/00; H04W 56/00

(52) U.S. Cl. CPC H04W 36/0061; H04W 56/0005

(57) ABSTRACT

A method performed by a UE for performing early UL synchronization for LTM is provided. The method includes receiving multiple candidate cell configurations for multiple candidate cells, each of the multiple candidate cell configurations corresponding to a candidate cell of the multiple candidate cells and indicating whether the UE is to perform the early UL synchronization; performing, before receiving a cell switch MAC CE, the early UL synchronization to one or more of the multiple candidate cells in a case that one or more of the multiple candidate cell configurations corresponding to the one or more of the multiple candidate cells indicate that the UE is to perform the early UL synchronization; receiving the cell switch MAC CE indicating that one of the multiple candidate cells is a target cell; and performing, based on the cell switch MAC CE, a cell switching from a source cell to the target cell.

### CROSS-REFERENCE TO RELATED APPLICATION(S)

The present disclosure claims the benefit of and priority to U.S. Provisional Patent Application Ser. No. 63/456,443, filed on Mar. 31, 2023, entitled “ENHANCEMENTS TO TA MANAGEMENT FOR LTM,” the content of which is hereby incorporated herein fully by reference into the present disclosure for all purposes.

### FIELD

The present disclosure is related to wireless communication and, more specifically, to a method, a user equipment (UE), and a base station (BS) for performing early uplink (UL) synchronization for layer 1 (L1)/layer 2 (L2)-triggered mobility (LTM) in cellular wireless communication networks.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to grow, there is a need for further improvements in wireless communication in the next-generation wireless communication systems.

### SUMMARY

The present disclosure is related to a method, a user equipment (UE), and a base station (BS) for performing early uplink (UL) synchronization for layer 1 (L1)/layer 2 (L2)-triggered mobility (LTM) in cellular wireless communication networks.

In a first aspect of the present application, a method performed by a UE for performing early UL synchronization for LTM is provided. The method includes receiving, from a base station (BS), multiple candidate cell configurations for multiple candidate cells, each of the multiple candidate cell configurations corresponding to a candidate cell of the multiple candidate cells and indicating whether the UE is to perform the early UL synchronization; performing, before receiving a cell switch medium access control (MAC) control element (CE), the early UL synchronization to one or more of the multiple candidate cells in a case that one or more of the multiple candidate cell configurations corresponding to the one or more of the multiple candidate cells indicate that the UE is to perform the early UL synchronization; receiving, from the BS, the cell switch MAC CE indicating that one of the multiple candidate cells is a target cell; and performing, based on the cell switch MAC CE, a cell switching from a source cell to the target cell. In a case that a candidate cell configuration corresponding to the target cell indicates that the UE is not to perform the early UL synchronization, the cell switch MAC CE further indicates information for UL synchronization and the UE performs, based on the information, the UL synchronization to the target cell upon receiving the cell switch MAC CE.

In an implementation of the first aspect, each of the one or more of the multiple candidate cell configurations further indicates that a UE-based TA measurement scheme is used to perform the early UL synchronization, and in a case that the UE-based TA measurement scheme is used to perform the early UL synchronization, the UE obtains a timing advance (TA) value of each of the one or more of the multiple candidate cells based on downlink (DL) signals from both the source cell and a corresponding candidate cell of the one or more of the multiple candidate cells.

In another implementation of the first aspect, each of the one or more of the multiple candidate cell configurations comprises a logical identity (ID) to indicate that the UE-based TA measurement scheme is used to perform the early UL synchronization.

In another implementation of the first aspect, each of the one or more of the multiple candidate cell configurations comprises a random access channel (RACH) configuration for a physical downlink control channel (PDCCH) order RACH procedure, and the UE performs the PDCCH order RACH procedure without receiving a random access response (RAR) for the early UL synchronization to each of the one or more of the multiple candidate cells.

In a second aspect of the present application, a UE for performing early UL synchronization for LTM is provided. The UE includes one or more processors; and at least one memory coupled to the one or more processors, the at least one memory storing computer-executable instructions that, when executed by the one or more processors, cause the UE to receive, from a base station (BS), multiple candidate cell configurations for multiple candidate cells, each of the multiple candidate cell configurations corresponding to a candidate cell of the multiple candidate cells and indicating whether the UE is to perform the early UL synchronization; perform, before receiving a cell switch medium access control (MAC) control element (CE), the early UL synchronization to one or more of the multiple candidate cells in a case that one or more of the multiple candidate cell configurations corresponding to the one or more of the multiple candidate cells indicate that the UE is to perform the early UL synchronization; receive, from the BS, the cell switch MAC CE indicating that one of the multiple candidate cells is a target cell; and perform, based on the cell switch MAC CE, a cell switching from a source cell to the target cell. In a case that a candidate cell configuration corresponding to the target cell indicates that the UE is not to perform the early UL synchronization, the cell switch MAC CE further indicates information for UL synchronization and the UE performs, based on the information, the UL synchronization to the target cell upon receiving the cell switch MAC CE.

In a third aspect of the present application, a BS for performing early UL synchronization for LTM is provided. The BS includes one or more processors; and at least one memory coupled to the one or more processors, the at least one memory storing computer-executable instructions that, when executed by the one or more processors, cause the BS to transmit, to a user equipment (UE), multiple candidate cell configurations for multiple candidate cells, each of the multiple candidate cell configurations corresponding to a candidate cell of the multiple candidate cells and indicating whether the UE is to perform the early UL synchronization; and transmit, to the UE, a cell switch medium access control (MAC) control element (CE) indicating that one of the multiple candidate cells is a target cell. In a case that a candidate cell configuration corresponding to the target cell indicates that the UE is not to perform the early UL synchronization, the cell switch MAC CE further indicates information for UL synchronization to the UE.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method performed by a UE for performing early UL synchronization for LTM, according to an example implementation of the present disclosure.

FIG. 2 is a flowchart illustrating a method performed by a BS for performing early UL synchronization for LTM, according to an example implementation of the present disclosure.

FIG. 3 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| BWP | Bandwidth Part |
| CA | Carrier Aggregation |
| CB | CodeBook |
| CBRA | Contention-Based Random Access |
| CFRA | Contention-Free Random Access |
| CORESET | Control Resource Set |
| CC | Component Carrier |
| CCE | Control Chanel Element |
| CE | Control Element |
| CHO | Conditional Hand Over |
| CPE | Customer Premises Equipment |
| CRC | Cyclic Redundancy Check |
| C-RNTI | Cell-Radio Network Temporary Identifier |
| CS-RNTI | Configured Scheduling-Radio Network Temporary |
| | Identifier |
| CSS | Common Search Space |
| CSI | Channel State Information |
| DAPS | Dual Active Protocol Stack |
| DC | Dual Connectivity |
| DCI | Downlink Control Information |
| DL | Downlink |
| FWA | Fixed Wireless Access |
| GC-PDCCH | Group Common-Physical Downlink Control Channel |
| HARQ | Hybrid Automatic Repeat Request |
| HO | Hand Over |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| L2 | Layer 2 |
| L3 | Layer 3 |
| MAC | Medium Access Control |
| MCG | Master Cell Group |
| MCS | Modulation Coding Scheme |
| MCS-C- | Modulation Coding Scheme-Cell-Radio Network |
| RNTI | Temporary Identifier |
| mTRP | Multiple Transmission Reception Point |
| MIMO | Multiple-input Multiple-output |
| MSB | Most Significant Bit |
| NACK | Negative Acknowledgment |
| NDI | New Data Indicator |
| Non-CB | non-CodeBook |
| NR | New RAT/Radio |
| NW | Network |
| PCI | Physical Cell ID |
| PCell | Primary Cell |
| PSCell | Primary Secondary Cell |
| PBCH | Physical Broadcast Channel |
| PDCCH | Physical Downlink Control Channel |
| PDSCH | Physical Downlink Shared Channel |
| PDU | Protocol Data Unit |
| P-MPR | Power management Maximum Power Reduction |
| PH | Power Headroom |
| PHR | Power Headroom Report |
| PHY | Physical (layer) |
| PRACH | Physical Random Access Channel |
| PTAG | Primary Timing Advance Group |
| PTRS | Phase Tracking Reference Signal |
| PUCCH | Physical Uplink Control Channel |
| PUSCH | Physical Uplink Shared Channel |
| RA | Random Access |
| RACH | Random Access Channel |
| RAN | Radio Access Network |
| RAR | Random Access Response |
| Rel | Release |
| RMSI | Remaining Minimum System Information |
| RNTI | Radio Network Temporary Identifier |
| RRC | Radio Resource Control |
| RS | Reference Signal |
| RSRP | Reference Signal Received Power |
| RSRQ | Reference Signal Received Quality |
| RSSI | Reference Signal Strength Indication |
| RV | Redundancy Version |
| SCell | Secondary Cell |
| SCG | Secondary Cell Group |
| SCS | Subcarrier Spacing |
| SDM | Spatial Domain Multiplexing |
| SFN | Single-Frequency Network |
| SINR | Signal to Interference plus Noise Ratio |
| SpCell | Special Cell |
| SR | Scheduling Request |
| SRI | SRS resource indicator |
| SRS | Sounding Reference Signal |
| SSB | Synchronization Signal Block |
| STAG | Secondary Timing Advance Group |
| STxMP | Simultaneous Transmission on Multiple Panels |
| TA | Timing Advance |
| TAG | Timing Advance Group |
| TB | Transport Block |
| TBS | Transport Block |
| TCI | Transmission Configuration Indication |
| TDM | Time Division Multiplexing |
| TPC | Transmission Power Control |
| TPMI | Transmission Precoding Matrix Indicator |
| TR | Technical Report |
| TRI | Transmit Rank Indication |
| TRP | Transmission Reception Point |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WCDMA | Wideband Code Division Multiple Access |
| WG | Working Group |
| WI | Working Item |
| ZP-CSI-RS | Zero power CSI-RS |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

Examples of some selected terms in the present disclosure are provided as follows.

Antenna Panel: A conceptual term for UE antenna implementation. It may be assumed that a panel is an operational unit for controlling a transmission spatial filter (beam). A panel may typically include multiple antenna elements. In some implementations, a beam may be formed by a panel. To form two beams simultaneously, two panels may be needed. Such simultaneous beamforming from multiple panels may be subject to a UE's capability (may also be referred to as UE capability in this disclosure). A similar definition for “panel” may be applicable by applying spatial receiving filtering characteristics.

Beam: The term “beam” may be interpreted as a spatial filter. For example, when UE reports a preferred gNB transmission (TX) beam, the UE may be essentially selecting a spatial filter used by the gNB. The term “beam information” may be used to provide information about which beam/spatial filter is being used/selected. In some implementations, individual reference signals may be transmitted by applying individual beams (spatial filters). Thus, the term “beam” or “beam information” may be represented by reference signal resource index(es).

DCI: There may be various DCI formats used in the LTE in the PDCCH. The DCI format may be a predefined format in which the DCI is packed/formed and transmitted in the PDCCH.

TCI state: A TCI state may include parameters for configuring a QCL relationship between one or two DL reference signals and a target reference signal set. For example, a target reference signal set may include the Demodulation Reference Signals (DM-RS) ports of a PDSCH or a PDCCH.

HARQ: A functionality ensures delivery between peer entities at Layer 1 (e.g., Physical Layer). A single HARQ process may support one Transport Block (TB) when the physical layer is not configured for downlink/uplink spatial multiplexing. When the physical layer is configured for downlink/uplink spatial multiplexing, a single HARQ process may support one or more TBs. There may be one HARQ entity per serving cell. Each HARQ entity may support a parallel (number) of DL and UL HARQ process.

In 3GPP RAN #97-e meeting, the LTM was approved as a work item in Rel-18 NR, with the following study details:

Specifying mechanisms and procedures for L1/L2-based inter-cell mobility to reduce mobility latency.

Configuring and maintaining multiple candidate cells for rapid application of configurations.

Establishing a dynamic switch mechanism among candidate serving cells, including SpCell and SCell, based on L1/L2 signaling.

Enhancing L1 for inter-cell beam management, including measurement, reporting, and beam indication.

### Managing Timing Advance.

If necessary, supporting L1/L2 mobility with CU-DU interface signaling.

Unlike legacy HO, such as the L3 HO, the CHO, and the DAPS, the LTM-based HO may be performed via the L1/L2 signaling, which may effectively reduce the HO latency. However, after, before, or during a UE is switched from the source cell to a selected candidate target cell, the UE may be required to perform the UL synchronization for one or more candidate target cells. Therefore, the present disclosure aims to design the UL synchronization method(s) that correspond to the LTM procedure. It may be noted that the selected candidate target cell may be a candidate target cell indicated to a UE for cell switching by the gNB.

The L1/L2 mobility may be an efficient way to reduce the latency of the HO since the decision and the measurement may be performed in the L2 and/or L1 (e.g., of the UE and/or of the gNB). During the LTM procedure, at least one of the following steps (A)-(D) may be involved to perform the LTM-based HO.

(A) LTM preparation: During this step, the UE may send a MeasurementReport message to the source cell/gNB, and the MeasurementReport message may be used for the indication of the measurement results. The MeasurementReport message and/or the measurement results may be dedicated to the LTM procedure. After the UE transmits the MeasurementReport message to the source cell/gNB, the source cell/gNB may decide to use the LTM and initiate the LTM candidate preparation. The source cell/gNB may transmit an RRCReconfiguration message to the UE, and the RRCReconfiguration message may include the configuration of one or more LTM candidate target cells. Then, the UE may receive the RRCReconfiguration message and store the RRCReconfiguration message. It may be noted that one RRCReconfiguration message may include one or more configurations corresponding to one or more candidate target cells. The configuration of a candidate target cell may be referred to as an LTM candidate configuration. In some implementations, the UE may release part or all of the RRCReconfiguration message when at least one of the following cases (a)-(g) occur.
(a) The timer (e.g., the timer T304 or an LTM dedicated timer) is expired.
(b) The LTM-based handover is completed.
(c) The source cell/gNB and/or the target cell/gNB transmits a new RRCReconfiguration message to the UE. It may be noted that the new RRCReconfiguration message may be a delta configuration or a full configuration of one or more LTM candidate target cells.
(d) The UE receives a list of LTM candidate target cell configurations or a list of LTM candidate target cell configuration IDs, to be released (e.g., in a ToReleaseLTMList IE).
(e) The UE receives an RRCReconfiguration message including a list of LTM candidate target cell configurations or a list of LTM candidate target cell configuration IDs, to be released (e.g., in a ToReleaseLTMList IE).
(f) The UE receives the reference configuration for the LTM and/or receives an RRCReconfiguration message including the reference configuration for the LTM. Subsequently, the UE may release the LTM candidate configurations (e.g., the LTM delta configuration, the LTM candidate configurations not relevant to the reference configuration, the LTM delta configurations, and the LTM reference configurations) and/or keep the reference configuration for the LTM.
(g) The UE receives an indication to keep (only) the reference configuration for the LTM and/or receives an RRCReconfiguration message including an indication to keep (only) the reference configuration for the LTM. Subsequently, the UE may release the LTM candidate configurations (e.g., the LTM delta configuration, the LTM candidate configurations not relevant to the reference configuration, the LTM delta configurations and the LTM reference configurations) and/or keep the reference configuration for the LTM.

It may be noted that part of the RRCReconfiguration message corresponding to the LTM may be the configurations of one or more candidate target cells and/or the partial configurations of each candidate target cell. It may be noted that part of the RRCReconfiguration message corresponding to the LTM may include the configurations of one or more candidate target cells, the partial configurations (e.g., the delta configurations) of each candidate target cell, the reference configurations of one or more candidate target cells, and/or the complete configurations of one or more candidate target cells.

(B) Early synchronization: During this step, the UE may perform the DL and/or UL synchronization to one or more candidate target cells before receiving the LTM cell switch command (or the LTM cell switch MAC CE). For the UL synchronization, the UE may perform the RACH-based scheme(s) and/or RACH-less scheme(s) to acquire the TA value of one or more candidate target cells.

In some implementations, the source cell/gNB may instruct the UE to perform the early DL and/or UL synchronization through RRC signaling. In some implementations, the configuration of one or more candidate target cells included in the RRCReconfiguration message may be used to indicate whether to perform the early DL and/or UL synchronization.

In some implementations, the RRCReconfiguration message may include one RRC parameter to indicate whether the UE is to perform the early DL and/or UL synchronization for candidate target cells. For example, the RRC parameter may be set to ‘enabled’ to instruct to the UE to perform the early DL and/or UL synchronization for the candidate target cells. Otherwise, the RRC parameter may be set to ‘disabled’ to instruct the UE not to perform the early DL and/or UL synchronization for the candidate target cells. The RRC parameter may be in a format of ENUMERATED {enabled'}, ENUMERATED {‘disabled’}, or ENUMERATED {enabled', ‘disabled’}. In some implementations, when the RRC parameter is in a format of ENUMERATED{enabled'} and if the RRC parameter is absent, it may mean that the UE does not perform the early DL and/or UL synchronization for the candidate target cells. When the RRC parameter is in a format of ENUMERATED {enabled'} and if the RRC parameter exists, it may mean that the UE performs the early DL and/or UL synchronization for the candidate target cells. In some implementations, when the RRC parameter is in a format of ENUMERATED {‘disabled’} and if the RRC parameter is absent, it may mean that the UE performs the early DL and/or UL synchronization for the candidate target cells. When the RRC parameter is in a format of ENUMERATED {‘disabled’} and if the RRC parameter exists, it may mean that the UE does not perform the early DL and/or UL synchronization for the candidate target cells.

In some implementations, the RRCReconfiguration message may include one or more RRC parameters to indicate whether the UE is to perform the early DL and/or UL synchronization for the corresponding candidate target cell. It may be noted that each RRC parameter may be associated with one or more candidate target cells. For example, the RRCReconfiguration message may include N configurations corresponding to N candidate target cells with one-by-one mapping. Each configuration may include one RRC parameter to indicate whether the UE is to perform the early DL and/or UL synchronization for the corresponding candidate target cell. For example, each RRC parameter may be set to ‘enabled’ to instruct to the UE to perform the early DL and/or UL synchronization for the corresponding candidate target cell. Each RRC parameter may be set to ‘disabled’ to instruct the UE not to perform the early DL and/or UL synchronization for the corresponding candidate target cell. The RRC parameter may be in a format of ENUMERATED {enabled'}, ENUMERATED {‘disabled’}, or ENUMERATED {enabled', ‘disabled’}. In some implementations, when the RRC parameter is in a format of ENUMERATED {enabled'} and if the RRC parameter is absent, it may mean that the UE does not perform the early DL and/or UL synchronization for the corresponding candidate target cell. When the RRC parameter is in a format of ENUMERATED {enabled'} and if the RRC parameter exists, it may mean that the UE performs the early DL and/or UL synchronization for the corresponding candidate target cell. In some implementations, when the RRC parameter is in a format of ENUMERATED {‘disabled’} and if the RRC parameter is absent, it may mean that the UE performs the early DL and/or UL synchronization for the corresponding candidate target cell. When the RRC parameter is in a format of ENUMERATED {‘disabled’} and if the RRC parameter exists, it may mean that the UE does not perform the early DL and/or UL synchronization for the corresponding candidate target cell.

In some implementations, the RRCReconfiguration message may include a set of SSB configurations. Each SSB configuration included in the set of SSB configurations may be associated with a candidate target cell. In some implementations, a UE may apply the set of SSB configurations for the DL synchronization to perform the early synchronization for the candidate target cells. In some implementations, a UE may apply one or more configurations included in the set of SSB configurations for the DL synchronization to perform the early synchronization for the candidate target cells. It may be noted that the one or more configurations may be indicated by the source cell/gNB via an RRC parameter or an RRC list included in the RRCReconfiguration message. For example, the UE may receive an RRC parameter used to indicate the number of candidate target cells configured for the early synchronization by the source cell/gNB. If the number of candidate target cells configured for the early synchronization is K, the UE may apply the first K-th SSB configurations included in the set of SSB configurations to perform the early synchronization for the corresponding candidate target cells. For example, the UE may receive an RRC list including one or more logical IDs of the candidate target cell. And the UE may perform the early DL synchronization for the candidate target cell(s) indicated in the RRC list.

In some implementations, a UE may be indicated to use what kind of scheme to perform the UL synchronization by the source cell/gNB via the RRC signaling. The scheme(s) indicated to the UE for acquiring the TA value of candidate target cell(s) may be at least one of the following (a)-(c).
(a) the PDCCH ordered RACH,
(b) the RACH-less mechanism (as in LTE), and
(c) the UE-based TA measurement.

(C) LTM execution: During this step, the UE may transmit one or more L1 measurement reports to the source cell/gNB. Based on the L1 measurement report(s) that the UE transmits to the source cell/gNB, the source cell/gNB may determine which candidate target cell is the target cell. Then, the source cell/gNB may transmit a cell switch command (or a cell switch MAC CE) to the UE to indicate the target cell. If the UE is not indicated to perform the early UL synchronization and/or the DL synchronization by the gNB, the UE may perform the UL synchronization and/or the DL synchronization to the target cell based on the information included in the cell switch command (or the cell switch MAC CE) and/or the configuration of the target cell. It may be noted that the configuration of the target cell may be included in the RRCReconfiguration message.

(D) LTM completion: During this step, the UE may transmit a message to the source cell/gNB and/or the target cell if the UE switches to the target cell successfully. It may be noted that the message may include HARQ-ACK information (e.g., an ACK and/or a NACK) transmitted on the PUCCH, the PUSCH, a confirmation MAC CE, or an RRC message (e.g., an RRC reconfiguration complete message) used to indicate that the LTM procedure is successfully completed.

In some implementations, if a UE receives and/or decodes a cell switch command successfully, the UE may transmit an ACK to the source cell and/or the target cell. If the UE fails to receive and/or decode the cell switch command, the UE may transmit a NACK to the source cell and/or the target cell. It may be noted that the HARQ-ACK information (e.g., the ACK or the NACK) may be transmitted on the PUCCH or the PUSCH. If the HARQ-ACK information (e.g., the ACK or the NACK) is transmitted on the PUCCH, the PUCCH may be scheduled by the DCI used to schedule the reception of the cell switch command.

In some implementations, the UE may (only) transmit a feedback to the source cell and/or the target cell when the UE receives/decodes the cell switch command successfully. For example, the UE may transmit an ACK to the source cell and/or the target cell if the UE receives and/or decodes a cell switch command successfully. If the UE fails to receive and/or decode the cell switch command, the UE may not transmit a NACK to the source cell and/or the target cell.

In some implementations, the UE may (only) transmit a feedback to the source cell and/or the target cell when the UE fails to receive/decode the cell switch command. For example, the UE may transmit a NACK to the source cell and/or the target cell if the UE fails to receive and/or decode the cell switch command. If the UE receives and/or decodes the cell switch command successfully, the UE may not transmit an ACK to the source cell and/or the target cell.

### RRC Pre-configuration for TA Acquisition Schemes

For the UL synchronization (e.g., the early UL synchronization or the UL synchronization after receiving the cell switch command), several TA acquisition schemes may be supported, such as the PDCCH ordered RACH, the SRS-based TA acquisition, the Rx timing difference-based scheme, the RACH-less scheme (as LTE), the UE-based TA measurement. Specifically, the early UL synchronization may mean that the UL synchronization corresponding to one or more candidate target cells will be completed before receiving the cell switch command.

In some implementations, the UE may receive an RRCReconfiguration message from the source cell/gNB, and the RRCReconfiguration message may include the configuration of the TA acquisition scheme(s). In some implementations, the RRCReconfiguration message may include an RRC field or an RRC parameter to indicate the UE which TA acquisition scheme is applied for the UL synchronization for the candidate target cells.

In some implementations, the RRCReconfiguration message may include an RRC field or an RRC parameter as follows:
TAAcquisitionScheme-r18 ENUMERATED {SchemeA, SchemeB, SchemeC}

It may be noted that the SchemeA, SchemeB, and SchemeC may represent the PDCCH ordered RACH, the RACH-less scheme (as LTE), and the UE-based TA measurement, respectively.

In some implementations, the RRCReconfiguration message may include an RRC field or an RRC parameter as follows:
TAAcquisitionScheme-r18 ENUMERATED {SchemeA, SchemeB, SchemeC, spare}

It may be noted that the SchemeA, SchemeB, and SchemeC may represent the PDCCH ordered RACH, the RACH-less scheme (as LTE), and the UE-based TA measurement, respectively. And ‘spare’ may be reserved.

In some implementations, the RRCReconfiguration message may include an RRC field or an RRC parameter as follows:
TAAcquisitionScheme-r18 ENUMBERATED {SchemeA, SchemeB}

It may be noted that the SchemeA and SchemeB may represent the PDCCH ordered RACH and RACH-less scheme (as LTE), respectively, or represent the PDCCH ordered RACH and the UE-based TA measurement, respectively.

In some implementations, the RRCReconfiguration message may include an RRC field or an RRC parameter as follows:
TAAcquisitionScheme-r18 ENUMERATED {SchemeA}

It may be noted that the SchemeA may represent one of the PDCCH ordered RACH, the RACH-less scheme (as LTE), the UE-based TA measurement, and Rx timing difference-based scheme. If the RRC field or the RRC parameter is ‘SchemeA’, the UE may apply the corresponding scheme represented by the SchemeA. If the RRC field or the RRC parameter is absent, the UE may not perform any TA acquisition or may perform the default scheme. For example, the default scheme may include one of the PDCCH ordered RACH, the RACH-less scheme (as LTE), the UE-based TA measurement, and the Rx timing difference-based scheme.

In some implementations, the RRCReconfiguration message may include an RRC field or an RRC parameter as follows:
TAAcquisitionScheme-r18 ENUMERATED {SchemeA, SchemeB, SchemeC, SchemeD}

It may be noted that the SchemeA, SchemeB, SchemeC, and ScehemeD may represent the PDCCH ordered RACH, the RACH-less scheme (as LTE), the UE-based TA measurement, and the Rx timing difference-based scheme, respectively.

In some implementations, each configuration corresponding to a candidate target cell (or each LTM candidate configuration) may include an RRC field or an RRC parameter to indicate the UE which TA acquisition scheme is applied for the UL synchronization for the corresponding candidate target cell.

In some implementations, each candidate target cell configuration (or each LTM candidate configuration) may include an RRC field or an RRC parameter as follows:
TAAcquisitionScheme-r18 ENUMERATED {SchemeA, SchemeB, SchemeC}

In some implementations, each candidate target cell configuration may include an RRC field or an RRC parameter as follows:
TAAcquisitionScheme-r18 ENUMERATED {SchemeA, SchemeB, SchemeC, spare}

It may be noted that the SchemeA, SchemeB, and SchemeC may represent the PDCCH ordered RACH, the RACH-less scheme (as LTE), and the UE-based TA measurement, respectively. And ‘spare’ may be reserved.

In some implementations, each candidate target cell configuration (or each LTM candidate target configuration) may include an RRC field or an RRC parameter as follows:
TAAcquisitionScheme-r18 ENUMERATED {SchemeA, SchemeB}

It may be noted that the SchemeA and SchemeB may represent the PDCCH ordered RACH and the RACH-less scheme (as LTE), respectively, or represent the PDCCH ordered RACH and the UE-based TA measurement, respectively.

In some implementations, each candidate target cell configuration (or each LTM candidate target configuration) may include an RRC field or an RRC parameter as follows:
TAAcquisitionScheme-r18 ENUMERATED {SchemeA}

It may be noted that the SchemeA may represent one of the PDCCH ordered RACH, the RACH-less scheme (as LTE), the UE-based TA measurement, and the Rx timing difference-based scheme. If the RRC field or the RRC parameter is ‘SchemeA’, the UE may apply the corresponding scheme represented by SchemeA for the corresponding candidate target cell. If the RRC field or the RRC parameter is absent, the UE may not perform any TA acquisition or may perform the default scheme for the corresponding candidate target cell. For example, the default scheme may include one of the PDCCH ordered RACH, the RACH-less scheme (as LTE), the UE-based TA measurement, and the Rx timing difference-based scheme.

In some implementations, each candidate target cell configuration may include an RRC field or an RRC parameter as follows:
TAAcquisitionScheme-r18 ENUMERATED {SchemeA, SchemeB, SchemeC, SchemeD}

It may be noted that the SchemeA, SchemeB, SchemeC, and ScehemeD may represent the PDCCH ordered RACH, the RACH-less scheme (as LTE), the UE-based TA measurement and the Rx timing difference-based scheme, respectively.

In some implementations, a UE may receive an RRCReconfiguration message from the source cell/gNB, and the RRCReconfiguration message may include the configuration used to indicate the UE to apply the RACH based scheme (e.g., the PDCCH ordered RACH) or the RACH-less scheme (e.g., the RACH-less scheme (as LTE), the UE-based TA measurement, and/or the Rx timing difference-based scheme) to acquire TA value(s) for the candidate target cells.

In some implementations, the RRCReconfiguration message may include an RRC field or an RRC parameter to indicate the UE to apply the RACH-based scheme or RACH-less scheme for the UL synchronization for the candidate target cells.

In some implementations, the RRCReconfiguration message may include an RRC field or an RRC parameter as follows:
TAAcquisitionScheme-r18 ENUMERATED {RACH-based scheme, RACH-less scheme}

In some implementations, each configuration corresponding to a candidate target cell may include an RRC field or an RRC parameter to indicate the UE to apply the RACH-based scheme or the RACH-less scheme for the UL synchronization for the corresponding candidate target cell.

In some implementations, each candidate target cell configuration may include an RRC field or an RRC parameter as follows:
TAAcquisitionScheme-r18 ENUMERATED {RACH-based scheme, RACH-less scheme}

### RACH-Based Scheme

In some implementations, the UE may be indicated, by the source cell/gNB, to perform the PDCCH ordered RACH to acquire the TA values of the corresponding candidate target cells.

For LTM, the preamble transmission initiated by the PDCCH ordered RACH may be transmitted on the LTM dedicated RACH resource(s). The RRCReconfiguration message may include the configuration of the LTM dedicated RACH resource(s), and the configuration of the LTM dedicated RACH resources may be applied for the PDCCH ordered RACH for the LTM.

Each configuration of the candidate target cell (or each LTM candidate configuration) indicated to the UE, by the source cell/gNB, to apply the PDCCH order RACH to acquire the TA value may include a configuration of the RACH resource(s). If a UE initiates the preamble transmission by the PDCCH order RACH corresponding to a candidate target cell, the UE may transmit the preamble on the RACH resource(s) configured for that candidate target cell.

In some implementations, the LTM dedicated RACH resource (or the RACH occasion) may be associated with one or more SSBs corresponding to different candidate target cells. For example, the LTM dedicated RACH resource (or the RACH occasion) may be associated with one or more additionalPCIIndex(s). For example, the LTM dedicated RACH resource (or the RACH occasion) may be associated with one or more SSB indexes. Each SSB index may be associated with the source cell and/or one or more candidate target cells. Each candidate target cell may be associated with one or more SSB indexes.

In some implementations, multiple LTM dedicated RACH resources (or RACH occasions) may be associated with one SSB corresponding to a candidate target cell. For example, multiple LTM dedicated RACH resources (or RACH occasions) may be associated with one additionalPCIIndex and/or SSB index. In some implementations, the number of SSBs per RACH occasion for the LTM CFRA may be indicated by an RRC parameter/field included in the configuration of the LTM dedicated RACH resource(s).

In some implementations, the RRCReconfiguration message may include one RRC parameter/field used to indicate whether a UE is required to receive an RAR or not when performing the PDCCH order RACH for the LTM.

In some implementations, the RRCReconfiguration message may include an RRC field or an RRC parameter as follows:

ReceivingRAR-r18 ENUMERATED {Receive, Not Receive}
ReceivingRAR-r18 ENUMERATED {Receive}
ReceivingRAR-r18 ENUMERATED {Not Receive}

The size of the field included in the RRCReconfiguration message may be 1 bit. For example, if the field is set to ‘Not Receive’ or is absent, the UE may not receive the RAR when performing the PDCCH order RACH for the LTM. For example, if the field is set to ‘Receive’ or is absent, the UE may receive the RAR when performing the PDCCH order RACH for the LTM.

The RRC parameter/field may be used to indicate the UE to receive an RAR or not when performing the PDCCH order RACH for the LTM via a bitmap. For example, if the field is set to ‘0’, the UE may not receive the RAR when performing the PDCCH order RACH for the LTM. Otherwise, the UE may receive the RAR when performing the PDCCH order RACH for the LTM. For example, if the field is set to ‘1’, the UE may receive the RAR when performing the PDCCH order RACH for the LTM. Otherwise, the UE may not receive the RAR when performing the PDCCH order RACH for the LTM.

In some implementations, each configuration of the candidate target cell(s) (or each LTM candidate configuration) indicating to the UE to apply the PDCCH order RACH to acquire the TA value may include an RRC parameter/field used to indicate whether the UE is required to receive an RAR or not when performing the PDCCH order RACH for the corresponding candidate target cell.

Each configuration of the candidate target cell(s) indicated to the UE to apply the PDCCH order RACH to acquire the TA value may include an RRC field or an RRC parameter as follows:

ReceivingRAR-r18 ENUMERATED {Receive, Not Receive}
ReceivingRAR-r18 ENUMERATED {Receive}
ReceivingRAR-r18 ENUMERATED {Not Receive}

The size of the field included in each configuration of the candidate target cell(s) indicated to the UE to apply the PDCCH order RACH to acquire the TA value may be 1 bit. For example, if the field is set to ‘Not Receive’ or is absent, the UE may not receive the RAR when performing the PDCCH order RACH for the LTM for the corresponding candidate target cell. For example, if the field is set to ‘Receive’ or is absent, the UE may receive the RAR when performing the PDCCH order RACH for the LTM for the corresponding candidate target cell.

The RRC parameter/field may be used to indicate the UE to receive an RAR or not when performing the PDCCH order RACH for the LTM via a bitmap. For example, if the field is set to ‘0’, the UE may not receive the RAR when performing the PDCCH order RACH for the corresponding candidate target cell. Otherwise, the UE may receive the RAR when performing the PDCCH order RACH for the corresponding candidate target cell. For example, if the field is set to ‘1’, the UE may receive the RAR when performing the PDCCH order RACH for the corresponding candidate target cell. Otherwise, the UE may not receive the RAR when performing the PDCCH order RACH for the corresponding candidate target cell.

In some implementations, if a UE is configured to receive the RAR, by the source cell/gNB, when performing the PDCCH order RACH for the LTM, the RRCReconfiguration message may include one RRC parameter/field used to indicate that the RAR is received from the source cell or the corresponding candidate target cell.

The RRCReconfiguration message may include an RRC field or an RRC parameter to indicate the UE to receive the RAR from the source cell or the corresponding candidate target cell for candidate target cells. For example, the RRCReconfiguration message may include an RRC field or an RRC parameter as follows:

RARPosition-r18 ENUMERATED {source cell, candidate target cell}
RARPosition-r18 ENUMERATED {source cell}
RARPosition-r18 ENUMERATED {candidate target cell}

The size of the RRC field included in the RRCReconfiguration message may be 1 bit. ‘source cell’ may be information associated with the source cell or the source cell itself. ‘candidate target cell’ may be information associated with the candidate target cell or the candidate target cell itself. For example, if the field is set to ‘source cell’ or is absent, the UE may receive the RAR from the source cell. For example, if the field is set to ‘candidate target cell’ or is absent, the UE may receive the RAR from the corresponding candidate target cell. For example, if the RRC field is set to ‘0’, the UE may be indicated to receive the RAR from the source cell. Otherwise, the UE may be indicated to receive the RAR from the corresponding candidate target cell. For example, if the field is set to ‘1’, the UE may be indicated to receive the RAR from the corresponding candidate target cell. Otherwise, the UE may be indicated to receive the RAR from the source cell.

In some implementations, if a UE is configured to receive the RAR, by the source cell/gNB, when performing the PDCCH order RACH for the LTM, each configuration of the candidate target cell(s) indicated to the UE to apply the PDCCH order RACH to acquire the TA value may include one RRC parameter/field used to indicate that the RAR is received from the source cell or the corresponding candidate target cell.

Each configuration of the candidate target cell(s) indicated to the UE to apply the PDCCH order RACH to acquire the TA value may include an RRC field or an RRC parameter as follows:

RARPosition-r18 ENUMERATED {source cell, candidate target cell}
RARPosition-r18 ENUMERATED {source cell}
RARPosition-r18 ENUMERATED {candidate target cell}

The size of the RRC field included in each configuration of the candidate target cell(s) indicated to the UE to apply the PDCCH order RACH to acquire the TA value may be 1 bit. ‘source cell’ may be information associated with the source cell or the source cell itself. ‘candidate target cell’ may be information associated with the candidate target cell or the candidate target cell itself. For example, if the field is set to ‘source cell’ or is absent, the UE may receive the RAR from the source cell. For example, if the field is set to ‘candidate target cell’ or is absent, the UE may receive the RAR from the corresponding candidate target cell. For example, if the RRC field is set to ‘0’, the UE may be indicated to receive the RAR from the source cell. Otherwise, the UE may be indicated to receive the RAR from the corresponding candidate target cell. For example, if the field is set to ‘1, the UE may be indicated to receive the RAR from the corresponding candidate target cell. Otherwise, the UE may be indicated to receive the RAR from the source cell.

In some implementations, when the UE performs the PDCCH order RACH to acquire the TA value for a candidate target cell, the DCI format used to initiate the PDCCH order RACH may include a field used to indicate that whether to receive an RAR. The size of the DCI field included in the DCI format used to initiate the PDCCH order may be 1 bit. For example, if the DCI field is set to ‘0’, the UE may be indicated to receive the RAR. Otherwise, the UE may be indicated not to receive the RAR. For example, if the DCI field is set to ‘0’, the UE may be indicated not to receive the RAR. Otherwise, the UE may be indicated to receive the RAR.

In some implementations, when the UE performs the PDCCH order RACH to acquire the TA value for a candidate target cell, the CRC of the DCI format (e.g., DCI format 1_0) used to initiate the PDCCH order RACH may be scrambled by a C-RNTI, a TC-RNTI, an RA-RNTI, and/or an LTM specific RNTI.

In some implementations, when the UE performs the PDCCH order RACH to acquire the TA value for a candidate target cell, the DCI format (e.g., DCI format 1_0) used to initiate the PDCCH order RACH may include a field used to indicate that the RAR is received from the source cell or the corresponding candidate target cell. The size of the DCI field included in the DCI format used to initiate the PDCCH order RACH for the LTM may be 1 bit. For example, if the DCI field is set to ‘0’, the UE may be indicated to receive the RAR from the source cell. Otherwise, the UE may be indicated to receive the RAR from the corresponding candidate target cell. For example, if the DCI field is set to ‘1’, the UE may be indicated to receive the RAR from the corresponding candidate target cell. Otherwise, the UE may be indicated to receive the RAR from the source cell.

In some implementations, the UE may be indicated with an LTM dedicated CSS for detecting and/or receiving the DCI format used to initiate the PDCCH order RACH for the candidate target cell. The configuration of the LTM dedicated CSS may be included in the RRCReconfiguration message. It may be noted that each candidate target cell may be associated with the same LTM dedicated CSS used for detecting and/or receiving the DCI format used to initiate the PDCCH order RACH for the candidate target cell(s). The configuration of the LTM dedicated CSS may be included in each configuration of the candidate target cell(s) indicated to the UE to apply the PDCCH order RACH to acquire the TA value.

In some implementations, the UE may be indicated with an LTM dedicated USS for detecting and/or receiving the DCI format used to initiate the PDCCH order RACH for the candidate target cell. The configuration of the LTM dedicated USS may be included in the RRCReconfiguration message. It may be noted that each candidate target cell may be associated with the same LTM dedicated USS used for detecting and/or receiving the DCI format used to initiate the PDCCH order RACH for the candidate target cell(s). The configuration of the LTM dedicated USS may be included in each configuration of the candidate target cell(s) indicated to the UE to apply the PDCCH order RACH to acquire the TA value.

In some implementations, the UE may be indicated, by the source cell/gNB, to perform the PDCCH order RACH without RAR reception. The UE may receive a NACK transmitted by the source cell/gNB and/or the corresponding target cell to indicate that the source cell/gNB and/or the corresponding candidate target cell fails to receive the preamble transmitted by the UE. The UE may receive an ACK transmitted by the source cell/gNB and/or the corresponding target cell to indicate that the source cell/gNB and/or the corresponding candidate target cell successfully receives the preamble transmitted by the UE.

In some implementations, the UE may be indicated, by the source cell/gNB, to perform the PDCH order RACH without RAR reception. In addition, the UE may be configured with a timing offset (or a timing window) by the source cell/gNB via the RRC signaling. The UE may expect to receive a response (e.g., an ACK, a NACK, and/or a confirmation MAC CE) transmitted by the source cell/gNB and/or the corresponding candidate target cell during the configured timing offset (or the timing window) after the UE transmits the preamble to the corresponding candidate target cell. It may be noted that if the UE does not receive any responses (e.g., the ACK, the NACK, and/or the confirmation MAC CE) during the timing offset (or the timing window) after the UE transmits the preamble to the corresponding candidate target cell, the UE may determine that the corresponding candidate target cell fails to receive the preamble transmitted by the UE.

In some implementations, the UE may be indicated, by the source cell/gNB, to perform the PDCH order RACH without RAR reception. In addition, the UE may be configured with a timing offset (or a timing window) by the source cell/gNB via the RRC signaling. The UE may expect to receive a response (e.g., an ACK, a NACK, and/or a confirmation MAC CE) transmitted by the source cell/gNB and/or the corresponding candidate target cell after the UE transmits the preamble to the corresponding candidate target cell if the configured timer is not expired. It may be noted that the configured timer may start when the UE transmits the preamble to the corresponding candidate target cell. In addition, if the UE does not receive any responses (e.g., the ACK, the NACK, and/or the confirmation MAC CE) before the timer is expired, the UE may determine that the corresponding candidate target cell fails to receive the preamble transmitted by the UE.

In some implementations, the UE may receive a cell switch command (or a cell switch MAC CE) transmitted by the source cell/gNB. The cell switch command may include a first field used to indicate the target cell, a second field used to indicate the TCI state corresponding to the target cell, and/or a third field used to indicate the TA value corresponding to the target cell.

If the TA value field included in the cell switch command is absent or the TA value field included in the cell switch command indicates a specific value (e.g., 0), the UE may transmit the preamble to the target cell on the configured RACH resource(s) (e.g., the RACH occasion). It may be noted that the configured RACH resource(s) may be included in the RRCReconfiguration message and/or the LTM candidate configuration corresponding to the target cell. It may be noted that the preamble index may be included in the cell switch command, the RRCReconfiguration message, and/or the LTM candidate configuration corresponding to the target cell.

It may be noted that the UE may apply the TCI state indicated in the cell switch command for the preamble transmission corresponding to the target cell. It may be noted that if the UE already transmitted the preamble to the target cell before receiving the cell switch command, the preamble transmitted after the cell switch command may be determined as a preamble retransmission. And the preamble retransmission may perform power ramping based on the power ramping parameter included in the cell switch command, the RRCReconfiguration message, and/or the LTM candidate configuration corresponding to the target cell.

In some implementations, the RRCReconfiguration message may include one RRC parameter/field used to indicate whether the UE is required to perform the PRACH retransmission or not if the source cell and/or candidate target cell fails to receive the preamble and/or if the UE is indicated not to receive the RAR for the PDCCH order RACH.

The RRCReconfiguration message may include an RRC field or an RRC parameter to indicate whether the UE is required to perform the PRACH retransmission or not if the source cell and/or candidate target cell fails to receive the preamble and/or if the UE is indicated not to receive the RAR for the PDCCH order RACH. For example, the RRCReconfiguration message may include an RRC field or an RRC parameter as follows:

PreambleRetransmission-r18 ENUMERATED {enabled, disabled}
PreambleRetransmission-r18 ENUMERATED {enabled}
PreambleRetransmission-r18 ENUMERATED {disabled}

The size of the RRC field included in the RRCReconfiguration message may be 1 bit. For example, if the field is set to ‘enabled’ or is absent, the UE may be enabled to perform the PRACH retransmission when the source cell and/or candidate target cell fails to receive the preamble. For example, if the field is set to ‘disabled’ or is absent, the UE may be disabled to perform the PRACH retransmission when the source and/or candidate target cell fails to receive the preamble. For example, if the RRC field is set to ‘0’, the UE may be enabled to perform the PRACH retransmission when the source cell and/or candidate target cell fails to receive the preamble. Otherwise, the UE may be disabled to perform the PRACH retransmission when the source cell and/or candidate target cell fails to receive the preamble. For example, if the field is set to ‘1’, the UE may be disabled to perform the PRACH retransmission when the source cell and/or candidate target cell fails to receive the preamble. Otherwise, the UE may be enabled to perform the PRACH retransmission when the source cell and/or candidate target cell fails to receive the preamble.

In some implementations, when the UE performs the PDCCH order RACH to acquire the TA value for a candidate target cell, the DCI format (e.g., DCI format 1_0) used to initiate the PDCCH order RACH may include a field used to indicate whether the UE is required to perform the PRACH retransmission or not if the source cell and/or candidate target cell fails to receive the preamble and/or if the UE is indicated not to receive the RAR for the PDCCH order RACH.

The size of the DCI field included in the DCI format (e.g., DCI format 1_0) used to initiate the PDCCH order RACH may be 1 bit. For example, if the DCI field is set to ‘0’, the UE may be enabled to perform the PRACH retransmission when the source cell and/or candidate target cell fails to receive the preamble. Otherwise, the UE may be disabled to perform the PRACH retransmission when the source cell and/or candidate target cell fails to receive the preamble. For example, if the DCI field is set to ‘1’, the UE may be disabled to perform the PRACH retransmission when the source cell and/or candidate target cell fails to receive the preamble. Otherwise, the UE may be enabled to perform the PRACH retransmission when the source cell and/or candidate target cell fails to receive the preamble.

In some implementations, when the UE performs the PDCCH order RACH to acquire the TA value for a candidate target cell, the DCI format (e.g., DCI format 1_0) used to initiate the PDCCH order RACH may include a field used to indicate whether the current PRACH transmission is retransmission or not. If the field indicates that the current PRACH transmission is retransmission, the UE may perform the power ramping for the current PRACH transmission based on the power ramping parameter indicated by the RRC signaling.

The size of the DCI field included in the DCI format (e.g., DCI format 1_0) used to initiate the PDCCH order RACH may be 1 bit. For example, if the DCI field is set to ‘0’, the UE may be indicated that the current PRACH transmission is a new transmission. Otherwise, the UE may be indicated that the current PRACH transmission is a retransmission. For example, if the DCI field is set to ‘1’, the UE may be indicated that the current PRACH transmission is a retransmission. Otherwise, the UE may be indicated that the current PRACH transmission is a new transmission.

The new data indicator (NDI) field in the DCI format may be (re) used to indicate that whether the current PRACH transmission is a new transmission. For example, if the NDI field is toggled (e.g., the NDI field in last DCI is 0 and the NDI field in current DCI is 1, or the NDI field in last DCI is 1 and the NDI field in current DCI is 0), the UE may be indicated that the current PRACH transmission is a new transmission. Otherwise, the UE may be indicated that the current PRACH transmission is a retransmission.

### RACH-Less Schemes

The RACH-less schemes may include the LTE/NR/LTM-based RACH-less scheme and the UE-based TA measurement.

In the following, the LTE/NR/LTM-based RACH-less scheme is described.

In some implementations, the RRCReconfiguration message may include a list of candidate target cells. The UE may be indicated to perform the RACH-less scheme (as LTE) for the candidate target cells configured in the list. Each candidate target cell may be configured with a logical ID by the source cell/gNB. The list of candidate target cells included in the RRCReconfiguration message may include the logical IDs of the candidate target cells that source cell/gNB instructed the UE to perform the RACH-less scheme (as LTE). And the UE may directly acquire the TA value of the target cell in the cell switch command if the logical ID of the target cell is included in the list of the candidate target cells that the source cell/gNB instructed the UE to perform the RACH-less scheme (as LTE).

In some implementations, the source cell/gNB may instruct the UE to perform the RACH-less scheme (as LTE) for the corresponding candidate target cell implicitly. If a UE is not instructed to apply the RACH-based scheme to acquire the TA values of candidate target cells, the UE may expect that it can directly acquire the TA value of the target cell by the cell switch command. If the configuration corresponding to a candidate target cell does not include the PRACH resource configuration for the PDCCH ordered RACH, the UE may assume that the TA acquisition scheme applied to that candidate target cell may be the RACH-less scheme (as LTE). Then, if the target cell indicated to the UE by the source cell/gNB is the candidate target cell without the PRACH configuration, the UE may expect that it can directly acquire the TA value of the target cell in the cell switch command.

In some implementations, when the UE is indicated to perform the LTE/NR-based RACH-less scheme, the cell switch command transmitted from the source cell/gNB may not include the TA value of the corresponding candidate cell and/or the target cell (or the TA field included in the cell switch command may be absent or not presented). The UE may be indicated to apply the LTE/NR-based RACH-less scheme to acquire the TA value for the corresponding candidate target cells and/or the target cell. If the TAG ID of the corresponding candidate target cells and/or the target cell is the same as the TAG ID of the source cell, the TA field included in the cell switch command may be absent or not be present.

In some implementations, when the UE receives the cell switch command, the UE may consider/expect that the TA field included in the cell switch command is absent or not be present if the TAG ID of the corresponding candidate target cells and/or the target cell is the same as the TAG ID of the source cell. If the TAG ID of the corresponding candidate target cells and/or the target cell is the same as the TAG ID of the source cell, the TA value of the corresponding candidate target cell and/or the target cell may be the same as the TA value of the source cell.

In some implementations, the UE may consider/expect that the TA value of the corresponding candidate target cell and/or the target cell may be the same as the TA value of the source cell if the TAG ID of the corresponding candidate target cells and/or the target cell is the same as the TAG ID of the source cell. If the TAG ID of the corresponding candidate target cells and/or the target cell is the same as the TAG ID of an SCell associated with the source cell, the TA field included in the cell switch command may be absent or not be present.

In some implementations, when the UE receives the cell switch command, the UE may consider/expect that the TA field included in the cell switch command is absent or not be present if the TAG ID of the corresponding candidate target cells and/or the target cell is the same as the TAG ID of an SCell associated with the source cell. If the TAG ID of the corresponding candidate target cells and/or the target cell is the same as the TAG ID of an SCell associated with the source cell, the TA value of the corresponding candidate target cell and/or the target cell may be the same as the TA value of the SCell associated with the source cell.

In some implementations, the UE may consider/expect that the TA value of the corresponding candidate target cell and/or the target cell may be the same as the TA value of the source cell if the TAG ID of the corresponding candidate target cells and/or the target cell is the same as the TAG ID of an SCell associated with the source cell.

In some implementations, the RRCReconfiguration message may include a list of candidate target cells. The UE may be indicated to perform the RACH-less scheme (as LTE) for the candidate target cells configured in the list. And the TA value of the candidate target cell(s) included in the list may be 0, the TA value of the source cell, and/or the TA value of the SCell associated with the source cell. The RRCReconfiguration message may include two lists of candidate target cells, the TA values of the candidate target cell included in the two lists may be 0 and the TA value of the source cell, respectively.

In some implementations, the RRCReconfiguration message may include configurations of candidate target cells. Among these candidate target cells, one or more candidate target cells may be indicated to the UE to apply the LTE/NR-based RACH-less scheme to acquire the TA value. The configurations of these candidate target cells configured with the LTE/NR-based RACH-less scheme may include one TA field to indicate the TA value. It may be noted that the TA value indicated in the TA field included in the configuration of a candidate target cell may be 0, the TA value of the source cell, or the TA value of the SCell corresponding to the source cell. It may be noted that the TA field included in the configuration of the candidate target cell may be absent if the candidate target cell is not indicated to the UE to perform the LTE/NR-based RACH-less scheme.

The size of the TA field included in the configuration of a candidate target cell may be 1 bit. For example, if the TA field is set to ‘0’, the TA value of the corresponding candidate target cell may be 0. Otherwise, the TA value of the corresponding candidate target cell may be the same as the TA value of the source cell. For example, if the TA field is set to ‘1’, the TA value of the corresponding candidate target cell may be 0. Otherwise, the TA value of the corresponding candidate target cell may be the same as the TA value of the source cell.

The size of the TA field included in the configuration of a candidate target cell may be 2 bits. For example, if the TA field is set to ‘00’, the TA value of the corresponding candidate target cell may be 0. If the TA field is set to ‘01’, the TA value of the corresponding candidate target cell may be the same as the TA value of the source cell. If the TA field is set to ‘10’, the TA value of the corresponding candidate target cell may be directly provided in the cell switch command. In addition, the codepoint ‘11’ may be reserved.

The size of the TA field included in the configuration of a candidate target cell may be 2 bits. For example, if the TA field is set to ‘00’, the TA value of the corresponding candidate target cell may be 0. If the TA field is set to ‘01’, the TA value of the corresponding candidate target cell may be the same as the TA value of the source cell. If the TA field is set to ‘10’, the TA value of the corresponding candidate target cell may be the same as the TA value of the SCell corresponding to the source cell. If the TA field is set to ‘11’, the TA value of the corresponding candidate target cell may be directly provided in the cell switch command.

In some implementations, if the target cell is the candidate target cell indicated to the UE to apply the LTE/NR-based RACH-less scheme to acquired TA value, the cell switch command transmitted from the source cell/gNB may not include the TA value of the corresponding candidate cell and/or the target cell (or the TA field included in the cell switch command may be absent or not presented).

In some implementations, if the target cell is the candidate target cell indicated to the UE to apply the LTE/NR-based RACH-less scheme to acquired TA value, the cell switch command may include one 1-bit field to indicate the TA value. If the 1-bit field is set to ‘0’, the TA value of the corresponding candidate target cell may be 0. Otherwise, the TA value of the corresponding candidate target cell may be the same as the TA value of the source cell. For example, if the 1-bit field is set to ‘1’, the TA value of the corresponding candidate target cell may be 0. Otherwise, the TA value of the corresponding candidate target cell may be the same as the TA value of the source cell.

In some implementations, if the TAG ID of the subsequent target cell is the same as the TAG ID of the current target cell, the TA value of the subsequent target cell may be the same as the TA value of the current target cell. In some implementations, if the TAG ID of the subsequent target cell is the same as the TAG ID of the current target cell, the cell switch command transmitted from the current target cell may not include the TA value of the subsequent target cell (or the TA field included in the cell switch command may be absent or not presented).

In the following, the UE-based TA measurement is described.

In some implementations, the RRCReconfiguration message may include a list of candidate target cells. The UE may be indicated to perform the UE-based TA measurement for the candidate target cells configured in the list.

Each candidate target cell may be configured with a logical ID by the source cell/gNB. The list of candidate target cells included in the RRCReconfiguration message may include the logical IDs of the candidate target cells that the source cell/gNB instructed the UE to perform the UE-based TA measurement. And the UE may not expect to acquire the TA value of the target cell in the cell switch command if the logical ID of the target cell is included in the list of the candidate target cells that the source cell/gNB instructed the UE to perform the UE-based TA measurement.

In some implementations, the source cell/gNB may instruct the UE to perform the UE-based TA measurement for the corresponding candidate target cell implicitly.

If a UE is not instructed to apply the RACH-based scheme to acquire the TA values of candidate target cells, the UE may apply the UE-based TA measurement to acquire the TA value of the corresponding candidate target cells. If the configuration corresponding to a candidate target cell does not include the PRACH resource configuration for the PDCCH ordered RACH, the UE may assume that the TA acquisition scheme applied to that candidate target cell may be the UE-based TA measurement. Then, if the target cell indicated to the UE by the source cell/gNB is the candidate target cell without the PRACH configuration, the UE may not expect to acquire the TA value of the target cell in the cell switch command.

In the following, the coexistence between the LTE/NR-based RACH-less scheme and the UE-based TA measurement is described.

In some implementations, the RRCReconfiguration message may include two lists of candidate target cells. The UE may be indicated to perform the LTE/NR-based RACH-less scheme and the UE based TA measurement for the candidate target cells configured in the two lists, respectively.

In some implementations, the RRCReconfiguration message may include the configurations of the candidate target cells. Among these candidate target cells, one or more candidate target cells may be indicated to the UE to apply the LTE/NR-based RACH-less scheme and/or the UE-based measurement to acquire the TA value. The configurations of these candidate target cells configured with the LTE/NR-based RACH-less scheme and/or the UE-based measurement may include one field to indicate the TA value and/or the RACH-less scheme. It may be noted that the TA value indicated in the field included in the configuration of a candidate target cell may be 0, the TA value of the source cell, or the TA value of the SCell corresponding to the source cell. It may be noted that the field included in the configuration of the candidate target cell may be absent if the candidate target cell is not indicated to the UE to perform the LTE/NR-based RACH-less scheme and/or the UE-based measurement.

The size of the field included in the configuration of a candidate target cell may be 1 bit. For example, if the field is set to ‘0’, the RACH-less scheme of the corresponding candidate target cell may be the LTE/NR-based RACH-less scheme. Otherwise, the RACH-less scheme of the corresponding candidate target cell may be the UE-based measurement. For example, if the field is set to ‘1’, the RACH-less scheme of the corresponding candidate target cell may be the UE-based measurement. Otherwise, the RACH-less scheme of the corresponding candidate target cell may be the LTE/NR-based RACH-less scheme.

The size of the field included in the configuration of a candidate target cell may be 2 bits. For example, if the field is set to ‘00’, the TA value of the corresponding candidate target cell may be 0. If the field is set to ‘01’, the TA value of the corresponding candidate target cell may be the same as the TA value of the source cell. If the field is set to ‘10’, the TA value of the corresponding candidate target cell may be directly provided in the cell switch command. If the field is set to ‘11’, the RACH-less scheme of the corresponding candidate target cell may be the UE-based measurement.

In some implementations, the UE may receive one RRC list included in the RRCReconfiguration message, and the RRC list may include at least one candidate target cell indicated to the UE to apply the LTE-based RACH-less scheme to acquire the TA value. In a case that the target cell is included in the RRC list, the UE may be indicated one TA value in the cell switch command transmitted from the source cell/gNB. It may be noted that the TA value of the target cell may be 0 or the TA value of the source cell.

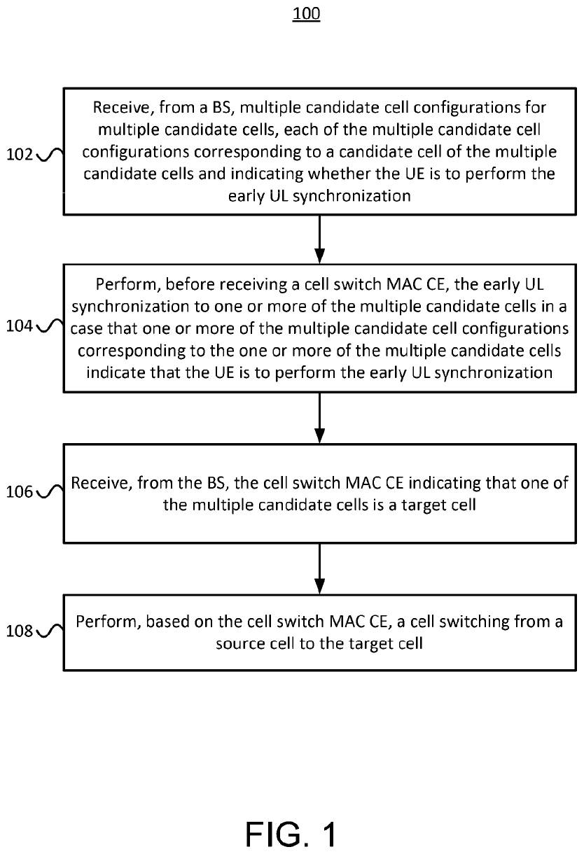

FIG. 1 is a flowchart 100 illustrating a method performed by a UE for performing early UL synchronization for LTM, according to an example implementation of the present disclosure.

In action 102, the UE may receive, from a BS, multiple candidate cell configurations for multiple candidate cells, each of the multiple candidate cell configurations may correspond to a candidate cell of the multiple candidate cells and indicating whether the UE is to perform the early UL synchronization. For example, the multiple candidate cell configurations may include a first candidate cell configuration, a second candidate cell configuration, a third candidate cell configuration, and a fourth candidate cell configuration. The multiple candidate cells may include a first candidate cell, a second candidate cell, a third candidate cell, and a fourth candidate cell. The first candidate cell configuration may correspond to the first candidate cell and indicate whether the UE is to perform the early UL synchronization. The second candidate cell configuration may correspond to the second candidate cell and indicate whether the UE is to perform the early UL synchronization. The third candidate cell configuration may correspond to the third candidate cell and indicate whether the UE is to perform the early UL synchronization. The fourth candidate cell configuration may correspond to the fourth candidate cell and indicate whether the UE is to perform the early UL synchronization.

In action 104, the UE may perform, before receiving a cell switch medium access control (MAC) control element (CE), the early UL synchronization to one or more of the multiple candidate cells in a case that one or more of the multiple candidate cell configurations corresponding to the one or more of the multiple candidate cells indicate that the UE is to perform the early UL synchronization. For example, in a case that the first candidate cell configuration corresponding to the first candidate cell indicates that the UE is to perform the early UL synchronization and the second candidate cell configuration corresponding to the second candidate cell indicates that the UE is to perform the early UL synchronization, the UE may perform, before receiving the cell switch MAC CE, the early UL synchronization to the first candidate cell and the early UL synchronization to the second candidate cell.

In some implementations, each of the one or more of the multiple candidate cell configurations may further indicate that a UE-based TA measurement scheme is used to perform the early UL synchronization, and in a case that the UE-based TA measurement scheme is used to perform the early UL synchronization, the UE may obtain a timing advance (TA) value of each of the one or more of the multiple candidate cells based on downlink (DL) signals from both the source cell and a corresponding candidate cell of the one or more of the multiple candidate cells. For example, the first candidate cell configuration may further indicate that the UE-based TA measurement scheme is used to perform the early UL synchronization and the second candidate cell configuration may further indicate that the UE-based TA measurement scheme is used to perform the early UL synchronization. In a case that the first candidate cell configuration indicates that the UE-based TA measurement scheme is used to perform the early UL synchronization and the second candidate cell configuration indicates that the UE-based TA measurement scheme is used to perform the early UL synchronization, the UE may obtain a TA value of the first candidate cell based on the DL signals from both the source cell and the first candidate cell and obtain a TA value of the second candidate cell based on the DL signals from both the source cell and the second candidate cell.

In some implementations, each of the one or more of the multiple candidate cell configurations may include a logical identity (ID) to indicate that the UE-based TA measurement scheme is used to perform the early UL synchronization. For example, the first candidate cell configuration may include a first logical ID to indicate that the UE-based TA measurement scheme is used to perform the early UL synchronization and the second candidate cell configuration may include a second logical ID to indicate that the UE-based TA measurement scheme is used to perform the early UL synchronization.

In some implementations, each of the one or more of the multiple candidate cell configurations may include a random access channel (RACH) configuration for a physical downlink control channel (PDCCH) order RACH procedure, and the UE may perform the PDCCH order RACH procedure without receiving a random access response (RAR) for the early UL synchronization to each of the one or more of the plurality of candidate cells. For example, the first candidate cell configuration may include a first RACH configuration for a first PDCCH order RACH procedure and the second candidate cell configuration may include a second RACH configuration for a second PDCCH order RACH procedure, and the UE may perform the first PDCCH order RACH procedure without receiving an RAR for the early UL synchronization to the first candidate cell and perform the second PDCCH order RACH procedure without receiving an RAR for the early UL synchronization to the second candidate cell.

In action 106, the UE may receive, from the BS, the cell switch MAC CE indicating that one of the multiple candidate cells is a target cell. For example, the cell switch MAC CE may indicate that the third candidate cell is a target cell.

In action 108, the UE may perform, based on the cell switch MAC CE, a cell switching from a source cell to the target cell. In a case that a candidate cell configuration corresponding to the target cell indicates that the UE is not to perform the early UL synchronization, the cell switch MAC CE may further indicate information for UL synchronization and the UE may perform, based on the information, the UL synchronization to the target cell upon receiving the cell switch MAC CE. For example, the UE may perform, based on the cell switch MAC CE, a cell switching from a source cell to the third candidate cell indicated as a target cell. In a case that the third candidate cell configuration corresponding to the third candidate cell that is indicated as a target cell indicates that the UE is not to perform the early UL synchronization, the UE may perform, based on information for UL synchronization indicated by the cell switch MAC CE, the UL synchronization to the third candidate cell upon receiving the cell switch MAC CE.

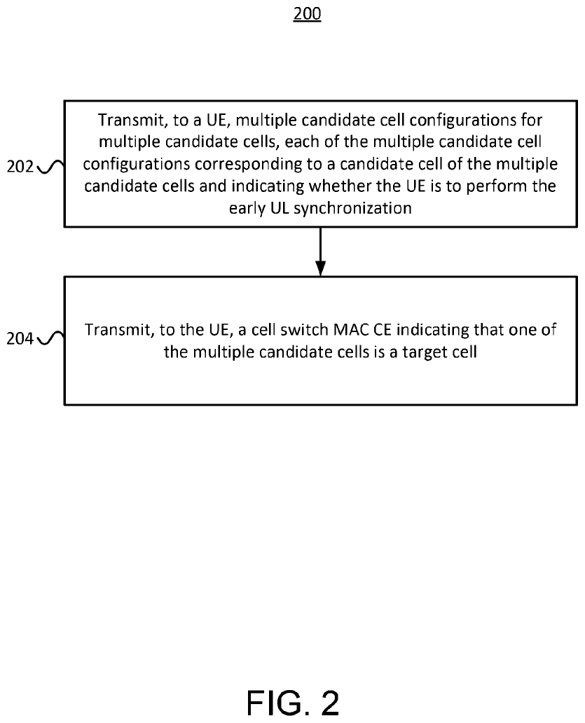

FIG. 2 is a flowchart 200 illustrating a method performed by a BS for performing early UL synchronization for LTM, according to an example implementation of the present disclosure.

In action 202, the BS may transmit, to a UE, multiple candidate cell configurations for multiple candidate cells, each of the multiple candidate cell configurations may correspond to a candidate cell of the multiple candidate cells and indicating whether the UE is to perform the early UL synchronization. For example, the multiple candidate cell configurations may include a first candidate cell configuration, a second candidate cell configuration, a third candidate cell configuration, and a fourth candidate cell configuration. The multiple candidate cells may include a first candidate cell, a second candidate cell, a third candidate cell, and a fourth candidate cell. The first candidate cell configuration may correspond to the first candidate cell and indicate whether the UE is to perform the early UL synchronization. The second candidate cell configuration may correspond to the second candidate cell and indicate whether the UE is to perform the early UL synchronization. The third candidate cell configuration may correspond to the third candidate cell and indicate whether the UE is to perform the early UL synchronization. The fourth candidate cell configuration may correspond to the fourth candidate cell and indicate whether the UE is to perform the early UL synchronization.

In some implementations, each of the one or more of the multiple candidate cell configurations may further indicate that a UE-based TA measurement scheme is used to perform the early UL synchronization. For example, the first candidate cell configuration may further indicate that the UE-based TA measurement scheme is used to perform the early UL synchronization and the second candidate cell configuration may further indicate that the UE-based TA measurement scheme is used to perform the early UL synchronization.

In some implementations, each of the one or more of the multiple candidate cell configurations may include a logical identity (ID) to indicate that the UE-based TA measurement scheme is used to perform the early UL synchronization. For example, the first candidate cell configuration may include a first logical ID to indicate that the UE-based TA measurement scheme is used to perform the early UL synchronization and the second candidate cell configuration may include a second logical ID to indicate that the UE-based TA measurement scheme is used to perform the early UL synchronization.

In some implementations, each of the one or more of the multiple candidate cell configurations may include a random access channel (RACH) configuration for a physical downlink control channel (PDCCH) order RACH procedure. For example, the first candidate cell configuration may include a first RACH configuration for a first PDCCH order RACH procedure and the second candidate cell configuration may include a second RACH configuration for a second PDCCH order RACH procedure.

In action 204, the BS may transmit, to the UE, a cell switch medium access control (MAC) control element (CE) indicating that one of the multiple candidate cells is a target cell. In a case that a candidate cell configuration corresponding to the target cell indicates that the UE is not to perform the early UL synchronization, the cell switch MAC CE may further indicate information for UL synchronization to the UE. For example, the cell switch MAC CE may indicate that the third candidate cell is a target cell. In a case that the third candidate cell configuration corresponding to the third candidate cell that is indicated as a target cell indicates that the UE is not to perform the early UL synchronization, the cell switch MAC CE may further indicate information for UL synchronization for the third candidate cell to the UE.

The technical problem addressed by the present disclosure is how to enable a UE to efficiently handle early uplink (UL) synchronization in scenarios involving LTM. This is particularly relevant in fast-moving cellular environments where timely and accurate synchronization is critical for maintaining seamless connectivity during cell transitions.

The advantageous technical effect achieved by the present disclosure is the improvement in the UEs ability to manage transitions between cells, especially when some candidate cells require early UL synchronization and others do not. This method ensures that the UE can pre-emptively synchronize with potential target cells, thereby reducing latency and improving the reliability of the network connection as the UE moves from one cell to another.

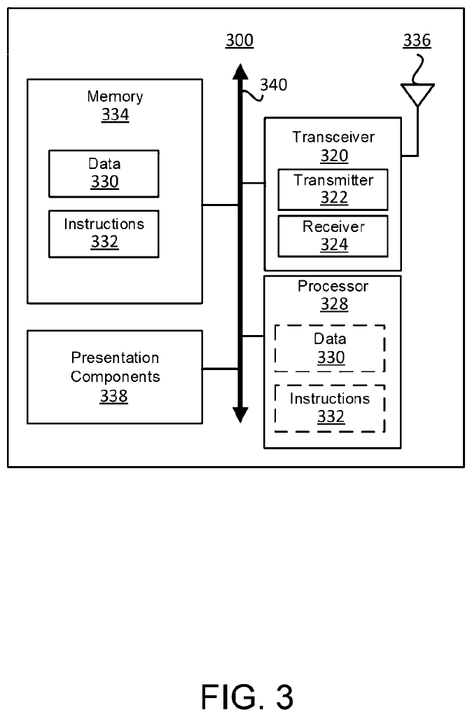

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 and 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 and 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A user equipment (UE) for performing early uplink (UL) synchronization for layer 1 (L1)/layer 2 (L2)-triggered mobility (LTM), the UE comprising:
at least one processor; and
at least one non-transitory computer-readable medium coupled to the at least one processor and storing one or more computer-executable instructions that, when executed by the at least one processor, cause the UE to:
receive, from a base station (BS), a plurality of candidate cell configurations for a plurality of candidate cells, each of the plurality of candidate cell configurations corresponding to a candidate cell of the plurality of candidate cells and indicating whether the UE is to perform an early UL synchronization with the corresponding candidate cell;
perform, before receiving a cell switch medium access control (MAC) control element (CE), the early UL synchronization with one or more of the plurality of candidate cells in a case that one or more of the plurality of candidate cell configurations corresponding to the one or more of the plurality of candidate cells indicate that the UE is to perform the early UL synchronization;
receive, from the BS, the cell switch MAC CE indicating that one of the plurality of candidate cells is a target cell; and
perform, based on the cell switch MAC CE, a cell switching from a source cell to the target cell, wherein, in a case that a candidate cell configuration corresponding to the target cell indicates that the UE is not to perform the early UL synchronization with the target cell:
the cell switch MAC CE further indicates information for a UL synchronization, and
the UE performs, based on the information, the UL synchronization with the target cell upon receiving the cell switch MAC CE.

2. The UE of claim 1, wherein:
each of the one or more of the plurality of candidate cell configurations further indicates that a UE-based timing advance (TA) measurement scheme is used to perform the early UL synchronization, and
the UE obtains a TA value for each of the one or more of the plurality of candidate cells based on downlink (DL) signals received from both the source cell and a corresponding candidate cell of the one or more of the plurality of candidate cells.

3. The UE of claim 2, wherein each of the one or more of the plurality of candidate cell configurations comprises a logical identity (ID) to indicate that the UE-based TA measurement scheme is used to perform the early UL synchronization.

4. The UE of claim 1, wherein:
each of the one or more of the plurality of candidate cell configurations comprises a random access channel (RACH) configuration for a physical downlink control channel (PDCCH) order RACH procedure, and
the UE performs the PDCCH order RACH procedure without receiving a random access response (RAR) for the early UL synchronization with each of the one or more of the plurality of candidate cells.

5. A method for performing, by a user equipment (UE), early uplink (UL) synchronization for layer 1 (L1)/layer 2 (L2)-triggered mobility (LTM), the method comprising:
receiving, from a base station (BS), a plurality of candidate cell configurations for a plurality of candidate cells, each of the plurality of candidate cell configurations corresponding to a candidate cell of the plurality of candidate cells and indicating whether the UE is to perform an early UL synchronization with the corresponding candidate cell;
performing, before receiving a cell switch medium access control (MAC) control element (CE), the early UL synchronization with one or more of the plurality of candidate cells in a case that one or more of the plurality of candidate cell configurations corresponding to the one or more of the plurality of candidate cells indicate that the UE is to perform the early UL synchronization;
receiving, from the BS, the cell switch MAC CE indicating that one of the plurality of candidate cells is a target cell; and
performing, based on the cell switch MAC CE, a cell switching from a source cell to the target cell, wherein, in a case that a candidate cell configuration corresponding to the target cell indicates that the UE is not to perform the early UL synchronization with the target cell:
the cell switch MAC CE further indicates information for a UL synchronization, and
the UE performs, based on the information, the UL synchronization with the target cell upon receiving the cell switch MAC CE.

6-8. (canceled)

9. A base station (BS) for performing early uplink (UL) synchronization for layer 1 (L1)/layer 2 (L2)-triggered mobility (LTM), the BS comprising:
at least one processor; and
at least one non-transitory computer-readable medium coupled to the at least processor and storing one or more computer-executable instructions that, when executed by the at least one processor, cause the BS to:
transmit, to a user equipment (UE), a plurality of candidate cell configurations for a plurality of candidate cells, each of the plurality of candidate cell configurations corresponding to a candidate cell of the plurality of candidate cells and indicating whether the UE is to perform an early UL synchronization with the corresponding candidate cell; and
transmit, to the UE, a cell switch medium access control (MAC) control element (CE) indicating that one of the plurality of candidate cells is a target cell, wherein:
the plurality of candidate cell configurations causes the UE to perform, before receiving the cell switch MAC CE, the early UL synchronization with one or more of the plurality of candidate cells in a case that one or more of the plurality of candidate cell configurations corresponding to the one or more of the plurality of candidate cells indicate that the UE is to perform the early UL synchronization,
the cell switch MAC CE causes the UE to perform, based on the cell switch MAC CE, a cell switching from a source cell to the target cell, and
in a case that a candidate cell configuration corresponding to the target cell indicates that the UE is not to perform the early UL synchronization with the target cell:
the cell switch MAC CE further indicates information for a UL synchronization, and
the cell switch MAC CE causes the UE to perform, based on the information, the UL synchronization with the target cell upon receiving the cell switch MAC CE.

10. The BS of claim 9, wherein:
each of the one or more of the plurality of candidate cell configurations further indicates that a UE-based timing advance (TA) measurement scheme is used to perform the early UL synchronization, and
each of the one or more of the plurality of candidate cell configurations causes the UE to obtain a TA value for each of the one or more of the plurality of candidate cells based on downlink (DL) signals transmitted from both the source cell and a corresponding candidate cell of the one or more of the plurality of candidate cells.

11. The BS of claim 10, wherein each of the one or more of the plurality of candidate cell configurations comprises a logical identity (ID) to indicate that the UE-based TA measurement scheme is used to perform the early UL synchronization.

12. The BS of claim 9, wherein;
each of the one or more of the plurality of candidate cell configurations comprises a random access channel (RACH) configuration for a physical downlink control channel (PDCCH) order RACH procedure, and
each of the one or more of the plurality of candidate cell configurations causes the UE to perform the PDCCH order RACH procedure without receiving a random access response (RAR) for the early UL synchronization with each of the one or more of the plurality of candidate cells.
